(19) United States
(12) Patent Application Publication
(10) Pub. No.: US 2009/0175547 A1
(43) Pub. Date: Jul. 9, 2009

(54) IMAGE PROCESSING APPARATUS AND IMAGE PROCESSING METHOD

(75) Inventor: Yuusuke Suzuki, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/349,990

(22) Filed: Jan. 7, 2009

Related U.S. Application Data
(60) Provisional application No. 61/019,790, filed on Jan. 8, 2008.

(51) Int. Cl. G06K 9/36

(52) U.S. Cl. 382/233

(57) ABSTRACT

In an image processing apparatus according to the present invention, an area dividing unit divides still image data into plural areas in two directions orthogonal to each other, an image-data arranging unit arranges, continuously in time series, plural image data corresponding to the plural areas included in the still image data, a compression encoding unit compression-encodes, using a moving image compression/expansion method, the plural image data corresponding to the plural areas arranged continuously in time series and generates a compression-encoded moving image signal, a decoding unit decodes, using the moving image compression/expansion method, the compression-encoded moving image signal and generates a decoded moving image signal, and a still-image-data generating unit generates still image data on the basis of the plural image data corresponding to the decoded moving image signal.

### CROSS-REFERENCE TO RELATED APPLICATION

This application is based upon and claims the benefit of priority from U.S. provisional application 61/019,790, filed on Jan. 8, 2008, the entire contents of which are incorporated herein by reference.

### TECHNICAL FIELD

The present invention relates to an image processing apparatus and an image processing method, and, more particularly to an image processing apparatus and an image processing method that are capable of compressing and expanding image data.

### BACKGROUND

There is known a technique for switching a compression/expansion processing unit using a selector to compress and expand a moving image and a still image. This technique is disclosed in JP-A-2004282444. With the technique proposed in JP-A-2004-282444, by diverting a signal to a display device of image data imaged by an imaging unit and using the signal for imaging of a moving image, it is possible to realize, with a small number of components, compression/expansion processing for the moving image. Further, by selecting, using a selector, signals from an external compression/expansion processing unit related to moving image processing and the imaging unit, it is possible to reproduce the moving image while suppressing an increase in a load on the processing.

However, in the technique proposed by JP-A-2004-282444, a frame size used if a moving image is imaged by the imaging unit is the same as a frame size of frames forming moving image data. A still image imaged in a frame size different from the frame size used if a moving image is imaged by the imaging unit cannot be compressed by using a compression/expansion system for moving images. Further, a moving image compressed by using the compression/expansion system for moving images cannot be expanded to a still image having a different frame size. Therefore, hardware exclusive for moving image compression/expansion cannot compress and expand a high-resolution image treated in printing, with use of the compression/expansion system for moving images.

### SUMMARY

The present invention has been devised in view of such circumstances and it is an object of the present invention to provide an image processing apparatus and an image processing method that can suitably compress and expand a still image treated in printing and the like, with use of a moving image compression/expansion system.

In order to solve the problem explained above, an image processing apparatus according to an aspect of the present invention includes: an area dividing unit configured to divide still image data into plural areas in two directions orthogonal to each other; an image-data arranging unit configured to arrange, continuously in time series, plural image data corresponding to the plural areas included in the still image data divided by the area dividing unit; a compression encoding unit configured to compression-encode, using a moving image compression/expansion method, the plural image data corresponding to the plural areas arranged continuously in time series by the image-data arranging unit and generate a compression-encoded moving image signal; a decoding unit configured to decode, using the moving image compression/expansion method, the compression-encoded moving image signal generated by the compression encoding unit and generates a decoded moving image signal; and a still-image-data generating unit configured to generate still image data on the basis of the plural image data corresponding to the decoded moving image signal generated by the decoding unit.

In order to solve the problem, an image processing method according to another aspect of the present invention includes: an area dividing step of dividing still image data into plural areas in two directions orthogonal to each other; an image-data arranging step of arranging, continuously in time series, plural image data corresponding to the plural areas included in the still image data divided by processing of the area dividing step; a compression encoding step of compression-encoding, using a moving image compression/expansion method, the plural image data corresponding to the plural areas arranged continuously in time series by processing of the image-data arranging step and generating a compression-encoded moving image signal; a decoding step of decoding, using the moving image compression/expansion method, the compression-encoded moving image signal generated by processing of the compression encoding step and generating a decoded moving image signal; and a still-image-data generating step of generating still image data on the basis of the plural image data corresponding to the decoded moving image signal generated by processing of the decoding step.

### DESCRIPTION OF THE DRAWINGS

In the accompanying drawings:

FIG. 1 is a block diagram of a configuration in the inside of an image processing apparatus according to an embodiment of the present invention;

FIG. 2 is a diagram for explaining a moving image compressing method employing the MPEG4 or H.264 method;

FIG. 3 is a block diagram of a configuration in the inside of an encoding unit of a moving image codec;

FIG. 4 is a block diagram of a configuration in the inside of a decoding unit of the moving image codec;

FIG. 5 is a flowchart for explaining compression/expansion processing in the image processing apparatus shown in FIG. 1;

FIG. 6 is a diagram of a method of dividing still image data;

FIG. 7 is a diagram for explaining a method of arranging plural image data corresponding to plural areas to continue in time series from the top in row and column order on a RAM;

FIG. 8 is a diagram for explaining a method of arranging plural image data corresponding to plural areas arranged in time series to continue in a memory address readout forward direction on a dedicated memory used by the moving image codec;

FIG. 9 is a diagram for explaining a concept of compressing or expanding plural document images with the moving image codec using a moving image compression/expansion system; and

FIG. 10 is a flowchart for explaining another kind of compression/expansion processing in the image processing apparatus shown in FIG. 1.

### DETAILED DESCRIPTION

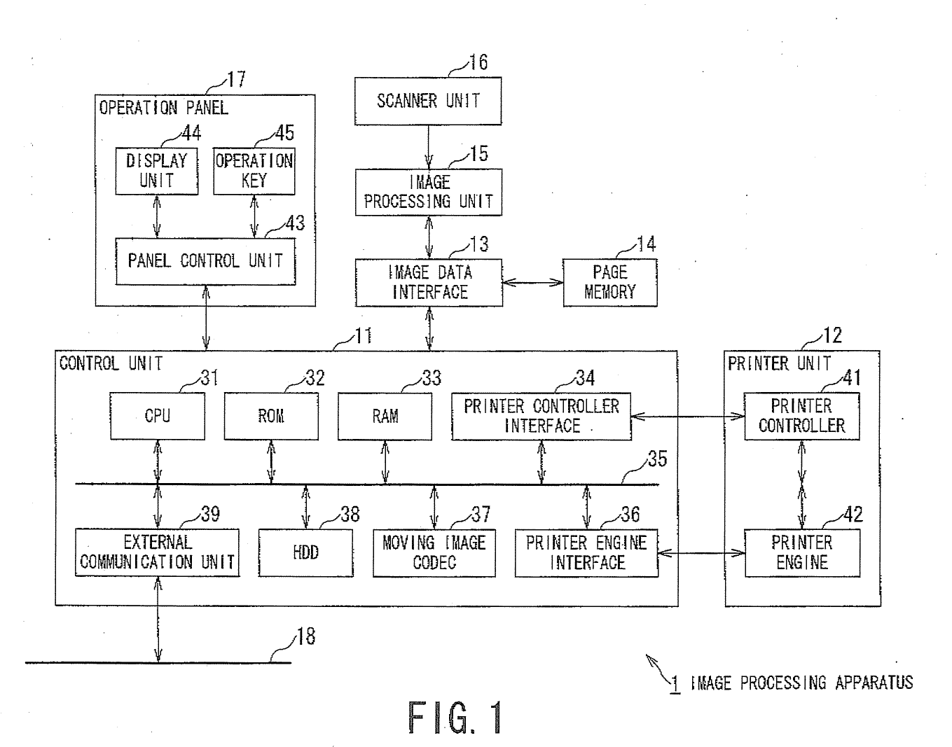

An embodiment according to the present invention is explained below with reference to the accompanying drawings. FIG. 1 is a diagram of a configuration in the inside of an image processing apparatus 1 according to this embodiment. For example, as shown in FIG. 1, the image processing apparatus 1 includes a control unit 11, a printer unit 12, an image data interface 13, a page memory 14, an image processing unit 15, a scanner unit 16, and an operation panel 17. The control unit 11 includes a CPU (Central Processing Unit) 31, a ROM (Read Only Memory) 32, a RAM (Random Access Memory) 33, a printer controller interface 34, a bus 35, a printer engine interface 36, a moving image codec 37, an HDD (Hard Disk Drive) 38 as an external recording device, and an external communication unit 39. These units are connected to one another via the bus 35. The CPU 31 executes various kinds of processing according to computer programs stored in the ROM 32 or various application programs loaded from the HDD 38 onto the RAM 33 and totally controls the image processing apparatus 1 by generating various control signals and supplying the control signals to the respective units. The RAM 33 appropriately stores data and the like necessary for the CPU 31 to execute the various kinds of processing. The external communication unit 39 includes a modem, a terminal adapter, and a network interface. The external communication unit 39 performs communication processing via a network 18. The HDD 38 appropriately records image data of a document compressed in a moving image format. The moving image codec 37 includes an encoder and a decoder and executes compression/expansion processing for moving image data. The moving image codec 37 may be configured by hardware or may be configured by software implemented by the CPU 31.

The printer unit 12, the image data interface 13, and the operation panel 17 are connected to the control unit 11. The control unit 11 transmits and receives compressed or uncompressed scanned image data (image signal) via the image data interface 13. The control unit 11 transmits compressed or uncompressed image data to and receives compressed or uncompressed image data from a printer controller 41 via the printer controller interface 34. The image data is image data for printing formed to be printed in a printer engine 42.

The operation panel 17 includes a panel control unit 43, a display unit 44, and an operation key 45. The display unit 44 includes an LCD (Liquid Crystal Display). The image processing unit 15 and the page memory 14 are connected to the image data interface 13. The scanner unit 16 is connected to the image processing unit 15. A flow of image data in forming an image is explained below. When an original is mounted on an original table glass, image data of the original is scanned by the scanner unit 16 and the scanned image data is supplied to the image processing unit 15. The image processing unit 15 acquires the image data of the original supplied from the scanner unit 16 and applies shading correction, various kinds of filtering processing, gradation processing, and gamma correction to the acquired image data. The image data after these kinds of processing is stored in the page memory 14 via the image data interface 13 if necessary. The printer unit 12 is driven according to the control by the control unit 11. The printer unit 12 includes the printer controller 41 that controls the printer engine 42 and the printer engine 42 that forms an image for printing.

As characteristic components according to the present invention, the control unit 11 includes an area dividing unit that divides still image data into plural areas in two directions orthogonal to each other, an image-data arranging unit that arranges, continuously in time series, plural image data corresponding to the plural areas included in the still image data divided by the area dividing unit, a still-image-data generating unit that generates (restores) the still image data on the basis of the plural image data corresponding to a decoded moving image signal generated by the moving image codec 37. These components are implemented as software on the CPU 31.

In this embodiment, a still image is divided into plural areas, plural images corresponding to the divided plural areas are treated as a frame group of a moving image, and the plural images are compressed by using the moving image compression/expansion system (compression/expansion method). The moving image compression/expansion system is explained below. In a moving image compressing method employing the MPEG (Moving Picture Experts Group) 4 or H.264 method, basically, a frame as an image for one screen is compressed by using the JPEG compression technique. Frames used in the moving image compressing method can be classified into three different frames such as an I frame, a P frame, and a B frame. The I frame is an intra-frame encoded image and is a frame in which data is completed in one frame. If the I frame is displayed, the frame can be displayed without using data of other frames at all. The P frame is called an inter-frame forward prediction encoded image and is a frame displayed by using frames displayed in the past. The P frame is stored as differential data of the I frame at the preceding time or the P frame at the preceding time. The P frame is displayed by using, as a predicted image, the I frame and the P frame displayed in the past. The B frame is called a bidirectional prediction decoded image and is a frame displayed by using frames in the past and in future. The B frame is stored as differential data of the I frame or the P frame at the preceding time and the I frame or the P frame at future time.

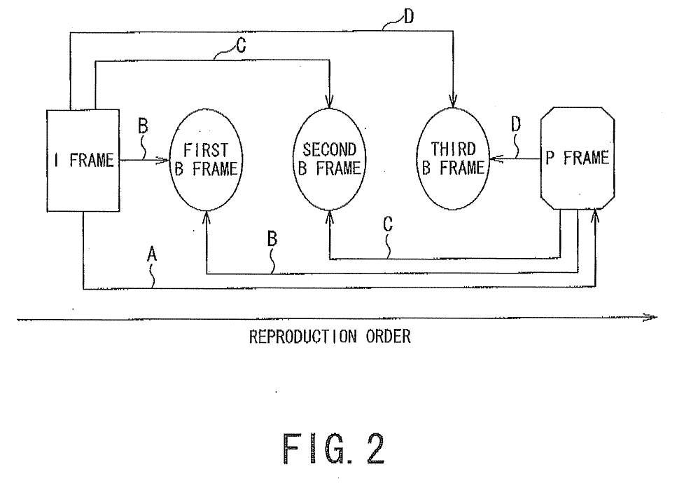

As shown in FIG. 2, the P frame is generated by using the I frame (as indicated by an arrow A in FIG. 2). A first B frame is generated by using the I frame and the P frame (as indicated by an arrow B in FIG. 2). A second P frame is generated by using the X frame and the P frame (as indicated by an arrow C in FIG. 2). A third B frame is generated by using the I frame and the P frame (as indicated by an arrow D in FIG. 2).

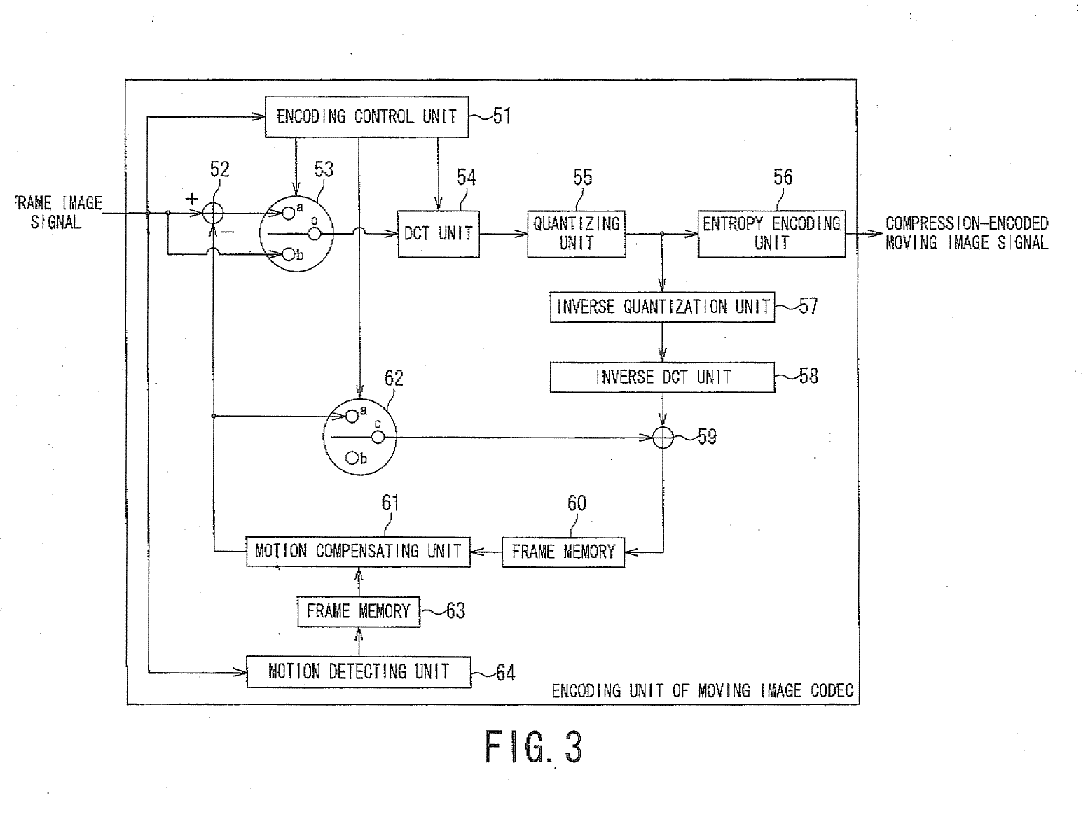

FIG. 3 is a diagram of a configuration in the inside of the encoding unit of the moving image codec 37. As shown in FIG. 3, the encoding unit of the moving image codec 37 includes an encoding control unit 51, an arithmetic unit 52, a switching circuit 53, a DCT (Discrete Cosine Transform) unit 54, a quantizing unit 55, an entropy encoding unit 56, an inverse quantization unit 57, an inverse DCT unit 58, an arithmetic unit 59, a frame memory 60, a motion compensating unit 61, a switching circuit 62, a frame memory 63, and a motion detecting unit 64.

The encoding control unit 51 totally controls the moving image codec 37. If intra frame encoding is performed as in the I frame, the switching circuit 53 is switched to connect a terminal “b” and a terminal “c”. Consequently, a frame image signal inputted to the moving image codec 37 is directly inputted to the DCT unit 54 via the switching circuit 53 without being inputted to the arithmetic unit 52. The DCT unit 54 applies DCT transform processing to the inputted frame image signal and outputs an image signal after DCT transform to the quantizing unit 55.

The quantizing unit 55 applies quantization processing to the image signal after the DCT transform outputted from the DCT unit 55, on the basis of a quantization value indicated by the encoding control unit 51. The quantizing unit 55 outputs the image signal after the quantization processing to the entropy encoding unit 56. The quantizing unit 55 outputs the image signal after the quantization processing to the inverse quantization unit 57 as well. The entropy encoding unit 56 entropy-encodes the image signal after the quantization processing and outputs the image signal after the entropy encoding to the bus 35 as a compression-encoded moving image signal.

The inverse quantization unit 57 applies inverse quantization processing to the image signal quantized by the quantizing unit 55 to reset the quantized image signal to the image signal after the DCT transform and outputs the image signal to the inverse DCT unit 58. The inverse DCT unit 58 applies inverse DCT transform processing to the image signal after the DCT transform outputted from the inverse quantization unit 57 to reset the DCT-transformed image signal to the image signal before the DCT transform and outputs the image signal to the arithmetic unit 59. If intra frame encoding is performed as in the I frame, the switching circuit 62 is switched to connect a terminal “b” and a terminal “c”. Consequently, the image signal before the DCT transform supplied from the inverse DCT unit 58 to the arithmetic unit 59 is directly stored in the frame memory 60 as a reference image signal.

On the other hand, if inter frame encoding is performed in a forward prediction mode as in the P frame or if inter frame prediction encoding is performed in a bidirectional prediction mode as in the B frame, the switching circuit 53 is switched to connect a terminal “a” and the terminal “c”. Consequently, the frame image signal inputted to the moving image codec 37 is inputted to the arithmetic unit 52.

The motion detecting unit 64 calculates motion vectors of respective macro blocks on the basis of macro block data and the reference image signal. The motion detecting unit 64 outputs calculated motion vector data to the frame memory 63. The frame memory 63 outputs the motion vector data to the motion compensating unit 61 after delaying the motion vector data by one frame.

As in the P frame, in the forward prediction mode, the motion compensating unit 61 reads out the reference image signal by shifting a readout address of the frame memory 60 according to the motion vector data and outputs the read-out reference image signal as a forward prediction image signal. In the case of the forward prediction mode, the switching circuit 62 is switched to connect a terminal “a” and the terminal “c”. Consequently, the forward prediction image signal is supplied to the arithmetic unit 52 and the arithmetic unit 59. The arithmetic unit 52 subtracts the forward prediction image signal from the frame image signal to obtain a differential signal of frame prediction and outputs the obtained differential signal to the DCT unit 54. Thereafter, the DCT unit 54 and the quantizing unit 55 apply DCT transform and quantization to the image signal, respectively.

The forward prediction image signal is supplied to the arithmetic unit 59 from the motion compensating unit 61. The arithmetic unit 59 adds the forward prediction image signal to the image signal before the DCT transform supplied from the inverse DCT unit 58 to thereby locally reproduce the reference image signal. The frame memory 60 stores the locally-reproduced reference image signal.

As in the B frame, in the bidirectional prediction mode, the motion compensating unit 61 shifts a readout address of the frame memory 60 according to motion vector data to thereby read out the reference image signal and outputs the read-out reference image signal as a bidirectional prediction image signal. In the case of the bidirectional prediction mode, the switching circuit 62 is switched to connect the terminal “a” and the terminal “c”. Consequently, the bidirectional prediction image signal is supplied to the arithmetic unit 52 and the arithmetic unit 59. The arithmetic unit 52 subtracts the bidirectional prediction image signal from the frame image signal to obtain a differential signal of frame prediction and outputs the obtained differential signal to the DCT unit 54. Thereafter, the DCT unit 54 and the quantizing unit 55 apply DCT transform and quantization to the image signal, respectively.

The bidirectional prediction image signal is supplied to the arithmetic unit 59 from the motion compensating unit 61. The arithmetic unit 59 adds the bidirectional prediction image signal to the image signal before the DCT transform supplied from the inverse DCT unit 58 to thereby locally reproduce the reference image signal. The frame memory 60 stores the locally-reproduced reference image signal.

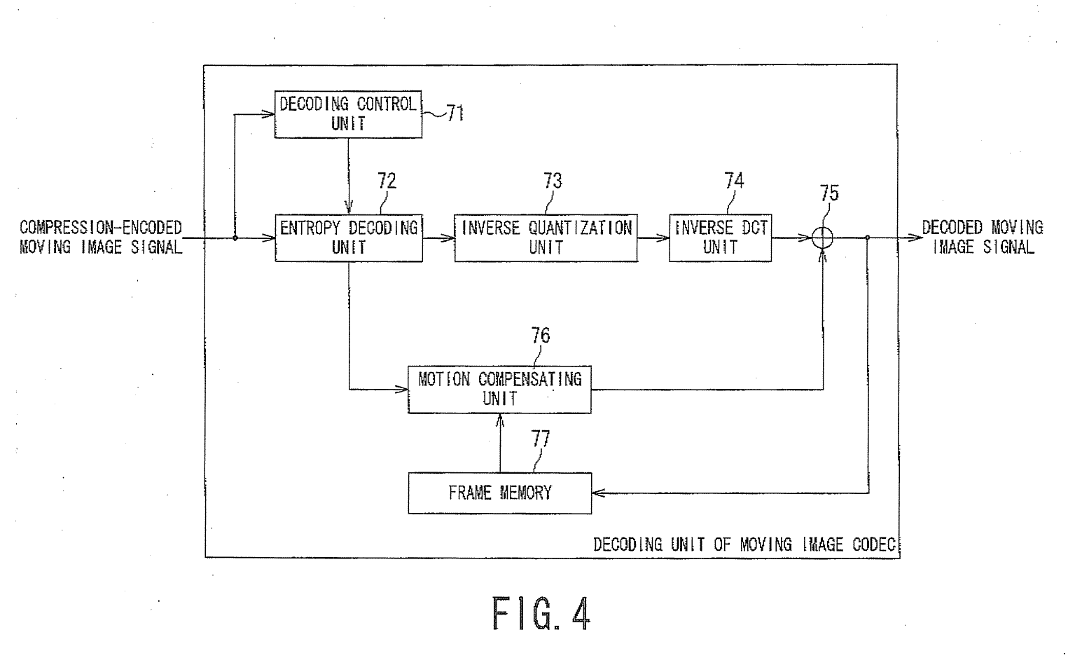

FIG. 4 is a diagram of a configuration in the inside of the decoding unit of the moving image codec 37. As shown in FIG. 4, the decoding unit includes a decoding control unit 71, an entropy decoding unit 72, an inverse quantization unit 73, an inverse DCT unit 74, an arithmetic unit 75, a motion compensating unit 76, and a frame memory 77. A decoding method for the moving image codec 37 is basically a process of a procedure opposite to the procedure of the encoding method explained with reference to FIG. 3. Explanation of the decoding method is omitted.

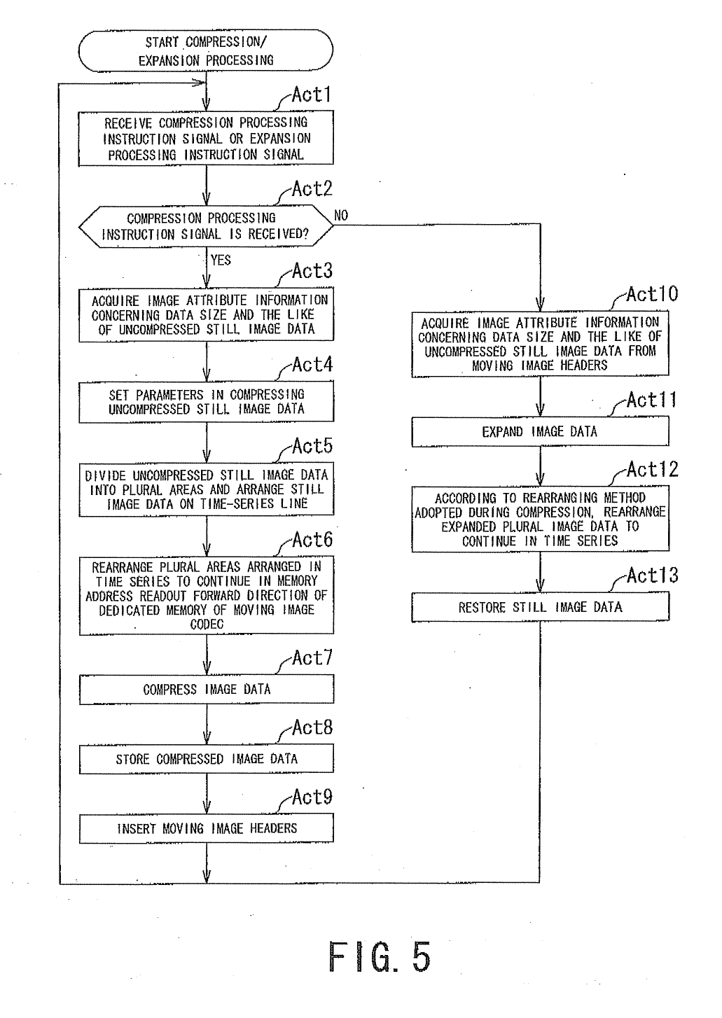

Compression/expansion processing in the image processing apparatus 1 shown in FIG. 1 is explained below with reference to a flowchart shown in FIG. 5. A control program for realizing the compression and expansion processing is automatically loaded onto the RAM 33 of the control unit 11 after the image processing apparatus 1 is started. The CPU 31 of the control unit 11 executes the compression and expansion processing indicated by the flowchart shown in FIG. 5 while reading out the data loaded onto the RAM 33 if necessary.

In ACT 1, the CPU 31 of the control unit 11 appropriately receives a compression processing instruction signal or an expansion processing instruction signal from the scanner unit 16 via the image data interface 13. Further, the CPU 31 of the control unit 11 appropriately receives the compression processing instruction signal or the expansion processing instruction signal via the printer controller interface 34. The compression processing instruction signal means a signal for instructing the moving image codec 37 to compress uncompressed image data. The expansion processing instruction signal means a signal for instructing the moving image codec 37 to expand compressed image data.

In ACT 2, the CPU 31 of the control unit 11 determines whether the received instruction signal is the compression processing instruction signal. If the CPU 31 of the control unit 11 determines in ACT 2 that the received instruction signal is the compression processing instruction signal, in ACT 3, the CPU 31 of the control unit 11 acquires, via the image data interface 13 or the printer controller interface 34, image attribute information concerning a data size and the like of uncompressed still image data to be compressed by using the moving image compression/expansion system. The image attribute information includes at least information concerning the width and the height of a still image to be uncompressed, information concerning color and monochrome of an uncompressed image, and information concerning the number of bits.

In ACT 4, the CPU 31 of the control unit 11 sets, in the moving image codec 37 via the bus 35, various parameters used in compressing the uncompressed still image data using the moving image compression/expansion system. For example, the parameters include a parameter concerning width and height corresponding to a frame size supported by the moving image codec 37, a parameter concerning the number of bits, and a parameter concerning a compression ratio. In ACT 5, the CPU 31 of the control unit 11 acquires, via the image data interface 13 or the printer controller interface 34, the uncompressed still image data to be compressed by using the moving image compression/expansion system. As a premise for transferring the still image data to the moving image codec 37, the CPU 31 of the control unit 11 first divides the still image data into plural areas according to a frame size set in the moving image codec 37.

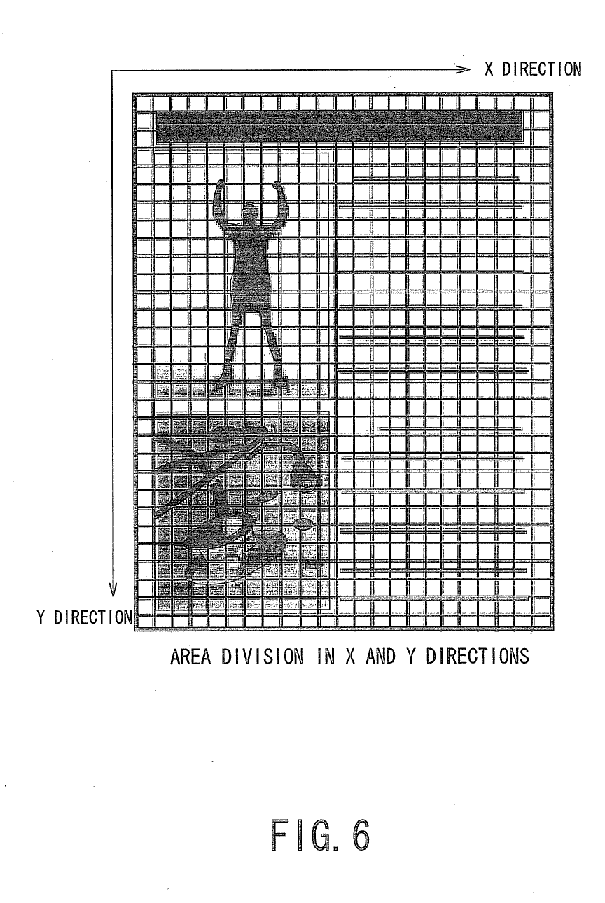

FIG. 6 is a diagram of a method of dividing still image data. As shown in FIG. 6, the CPU 31 of the control unit 11 divides, according to the frame size set in the moving image codec 37, the still image data into plural areas in an X direction (a lateral direction) and a Y direction (a longitudinal direction). If the still image data is divided according to the frame size set in the moving image codec 37, an unnecessary image area is formed at an end of the still image data. In such a case, the CPU 31 of the control unit 11 divides the still image data according to the frame size after adding image data of a base color of a document to the still image data.

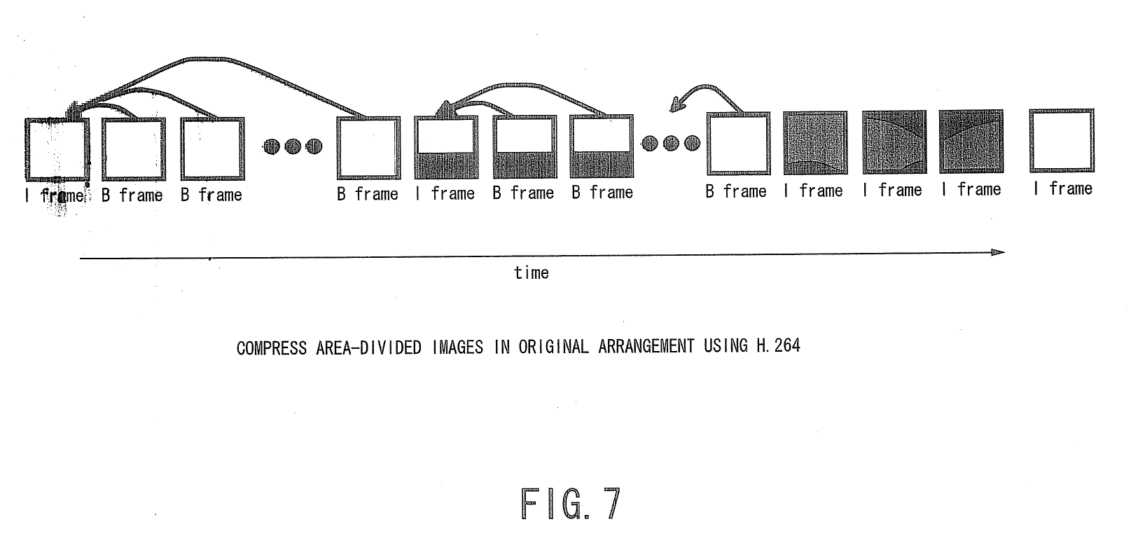

The CPU 31 of the control unit 11 treats, as moving image frames, respective image data corresponding to the respective areas divided according to the frame size used in the moving image codec 37. As shown in FIG. 7, the CPU 31 of the control unit 11 arranges plural image data corresponding to the plural areas to logically continue in time series from the top in row and column order on the RAM 33. In this case, if there is almost no motion prediction value (i.e., there is almost no change among the frames), the image data are arranged to be compressed in a B frame format, which is differential data from a preceding frame. On the other hand, if portions including characters and graphics continue in a still image, the CPU 31 of the control unit 11 arranges, without using prediction of preceding and following frames, the image data to be compressed in an I frame format in which encoding is completed. This makes it possible to compress the image data with deterioration in images in divided areas such as characters, graphics, and photographs suppressed while maintaining a high compression ratio in the entire still image.

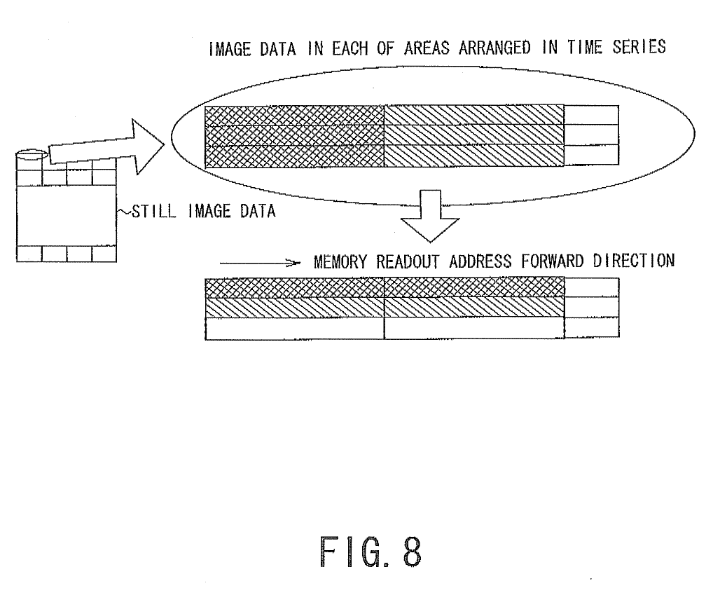

In ACT 6, the CPU 31 of the control unit 11 rearranges the image data corresponding to the plural areas arranged in time series on the RAM 33 to continue in a memory address readout forward direction on a dedicated memory used by the moving image codec 37 in compressing or expanding the image data. As shown in FIG. 8, plural image data corresponding to plural areas arranged in time series are rearranged to continue in the memory address readout forward direction on the dedicated memory used by the moving image codec 37 in compressing or expanding the image data. This makes it possible to improve efficiency in compression or expansion of the plural image data by the moving image codec 37. If the moving image codec 37 compresses or expands the image data, the RAM 33 may be shared with the CPU 31 instead of the dedicated memory.

In ACT 7, the CPU 31 of the control unit 11 controls the moving image codec 37 to sequentially compress the image data corresponding to the plural divided areas as moving image frames using the moving image compression/expansion system (e.g., the MPEG 4 or H.264 method). The moving image codec 37 sequentially compresses, according to the control by the CPU 31 of the control unit 11, the plural image data corresponding to the plural divided areas included in the still image data using the moving image compression/expansion method and generates compression-encoded moving image signals. The moving image codec 37 sequentially stores the generated compression-encoded moving image signals in the dedicated memory. In ACT 8, the CPU 31 of the control unit 11 records (stores) the compression-encoded moving image signals generated by using the moving image compression/expansion system in the HDD 38. In ACT 9, after the compression processing in the moving image codec 37, the CPU 31 of the control unit 11 inserts image attribute information concerning a data size and the like of uncompressed still image data in header areas of the generated compression-encoded moving image signal (compressed moving image data). Thereafter, the processing returns to ACT 1.

On the other hand, if the CPU 31 of the control unit 11 determines in ACT 2 that the received instruction signal is not the compression processing instruction signal (i.e., the received instruction signal is the expansion instruction signal), in ACT 10, the CPU 31 of the control unit 11 reads out the compressed moving image data recorded in the HDD 38 onto the RAM 33 and acquires, out of the read-out compressed moving image data, the image attribute information included in the header areas of the compressed moving image data. In ACT 11, the CPU 31 of the control unit 11 controls the moving image codec 37 to expand the readout compressed moving image data. The moving image codec 37 expands, according to the control by the CPU 31 of the control unit 11, the compressed moving image data using the moving image compression/expansion system, sequentially generates decoded moving image signals (frame image signals), and stores the generated decoded moving image signals in the dedicated memory. In ACT 12, the CPU 31 of the control unit 11 rearranges, according to the rearranged method adopted during the compression, the image data in the divided areas corresponding to the decoded moving image signals stored in the dedicate memory to continue in time series on the RAM 33. In ACT 13, the CPU 31 of the control unit 11 restores, on the basis of the acquired image attribute information, the image data in the divided areas corresponding to the decoded moving image signals (the frame image signals) stored in the RAM 33 to the original still image data. In other words, the CPU 31 of the control unit 11 generates the original still image data on the basis of the image data in the divided areas corresponding to the decoded moving image signals (the frame image signals). This makes it possible to restore the still image data before the compression on the RAM 33.

In particular, the compression/expansion processing shown in FIG. 5 can be applied to electronic sorting of copy processing or print processing in the image processing apparatus 1. Specifically, in the case of the copy processing, the control unit 11 receives a compression processing instruction signal from the scanner unit 16, thereafter acquires document image data scanned by the scanner unit 16 via the image data interface 13, and stores the acquired document image data in the RAM 33. On the other hand, in the case of the print processing, the control unit 11 receives a compression processing instruction signal from the printer controller 41, acquires raster image data of a document image subjected to image formation processing by the printer controller 41 via the printer controller interface 34, and stores the acquired raster image data in the RAM 33. After being read onto the RAM 33, the raster image data for printing is compressed in a moving image compression format by the compression system shown in FIG. 5. The compressed moving image data is transferred to the HDD 38 via the bus 35 and stored (recorded) in the HDD 38. In this way, all documents included in one print job are sequentially stored in the HDD 38. The control unit 11 of the image processing apparatus 1 sequentially transmits the document image data after the decoding to the printer engine 42 while decoding, with the moving image codec 37, the moving image data after the compression stored in the HDD 38 in order of sorting of the documents. The printer engine 42 sequentially receives the document image data after the decoding and outputs hard copies in a form in which the received document image data are sorted.

The execution of the compression/expansion processing shown in FIG. 5 by the control unit 11 of the image processing apparatus 1 makes it possible to provide a buffer substantially between the printer controller 41 and the printer engine 42. Image data used for image formation in the printer engine 42 has high resolution and a large data amount. The printer engine 42 needs to process the image data on a real time basis and record the image data on sheets serving as print media. Therefore, respective interfaces used for communication between the printer controller 41 and the printer engine 42 are, in general, interfaces that can transmit a large amount of data at high speed. However, if the processing for forming raster image data on the printer controller 41 side delays and, as a result, timing for transmitting the raster image data from the printer controller 41 to the printer engine 42 delays with respect to timing of communication processing between the printer controller 41 and the printer engine 42, the raster image data is not printed by the printer engine 42 and documents are not correctly printed.

In this embodiment, the control unit 11 can receive the raster image data from the printer controller 41 via the printer controller interface 34 during printing and continue the compression processing until the raster image data, a portion of which equivalent to one page of a document is still image data, is compressed as moving image data. After the completion of the compression processing, the control unit 11 can transmit the raster image data to the printer engine 42 via the printer engine interface 36 while decoding the moving image data with the moving image codec 37 again awaiting the expansion processing instruction signal from the printer controller 41. This operation corresponds to the execution of ACTS 1 and 2 and ACTS 10 to 12 after ACTS 1 to 9 shown in FIG. 5. This makes it possible to realize a high-speed communication buffer between the printer controller 41 and the printer engine 42 using the control unit 11 and stably perform printing of a document image in the printer engine 42.

Compressed moving image data of the document image may be displayed on the display unit 44 of the operation panel 17 of the image processing apparatus 1 while being decoded. Consequently, a user can see contents of the document on a display monitor in order while decoding the compressed moving image data of the document image and check the contents of the document before printing.

In the embodiment of the present invention, it is possible to divide still image data into plural areas in two directions orthogonal to each other, arrange, continuously in time series, plural image data corresponding to the plural areas included in the divided still image data, compression-encode, using the moving image compression/expansion system, the plural image data corresponding to the plural areas arranged continuously in time series and generate a compression-encoded moving image signal, decode, using the moving image compression/expansion system, the generated compression-encoded moving image signal and generate a decoded moving image signal, and generate still image data on the basis of the plural image data corresponding to the generated decoded moving image signal.

Consequently, in a system that can treat moving image data, it is possible to suitably compress and expand still image data having high resolution and a large data size using the moving image compression/expansion system and compress and expand the still image data at high speed. When the compressed moving image data is decoded, an image based on moving image data can be appropriately displayed. Therefore, it is possible to suitably compress and expand still images used in printing and the like using the moving image compression/expansion system.

In the compression/expansion processing explained with reference to the flowchart shown in FIG. 5, one still image is compressed by using the moving image compression/expansion system such that the compression is completed in the one still image. However, the present invention is not limited to this. For example, when document images for plural documents are compressed by using the moving image compression/expansion system, rather than sequentially compressing the document images such that the compression is completed for each of still images, the plural document images may be compressed by using similarity of the document images. Specifically, in the case of a document created in a format determined in advance such as a material for presentation or a report, a background of the document, a logotype, a page header, and the like are often common among plural documents. Therefore, image data in the same image area is common among plural different documents. Therefore, divided areas corresponding to the image area common among the plural different documents are arranged as moving image frames adjacent to one another in time series and compressed by making use of this characteristic. This makes it possible to compress the plural document images at a higher compression ratio with the moving image codec 37.

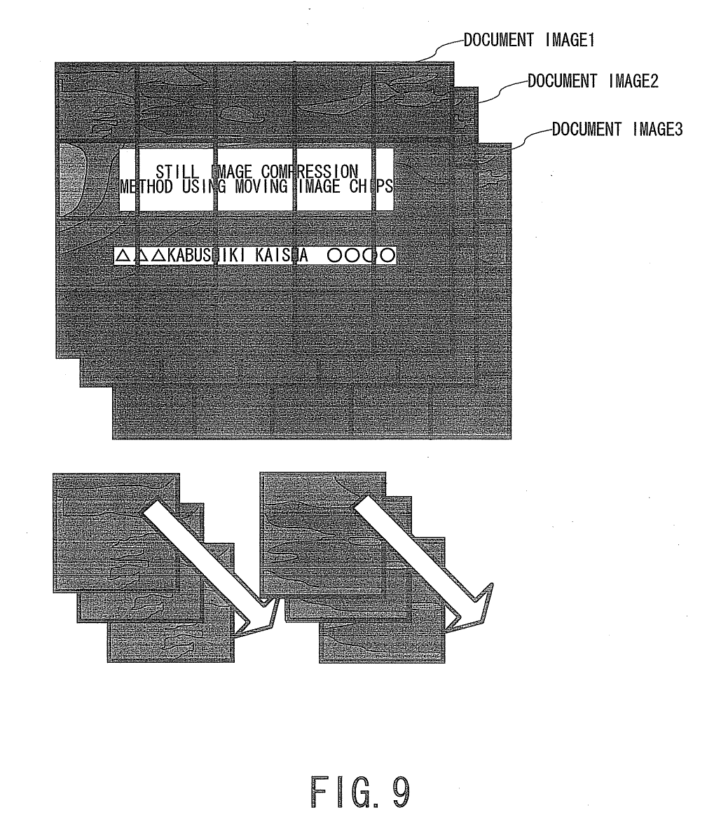

A concept of compressing and expanding the plural document images with the moving image codec 37 using the moving image compression/expansion system is explained with reference to FIG. 9. In the case of FIG. 9, all document images 1 to 3 are images of presentation materials in which backgrounds are photographs. The photographs of the backgrounds are common in all the document images. In the document images 1 to 3, characters, graphics, and photograph objects written and drawn on the photographs of the backgrounds are different depending on the respective document images. When such document images are compressed or expanded by using the moving image compression/expansion system, the respective document images are divided into plural areas in the same manner as the compression/expansion processing shown in FIG. 5 and the divided plural areas are arranged on a time-series line and compressed. The same divided areas corresponding to a portion common in all the document images are arranged as continuous moving image frames and compressed. Concerning the same divided areas corresponding to the portion common in all the document images, a background image of the same pattern is only present if no characters, graphics photographic objects, and the like are written and drawn. Therefore, even if the divided areas are arranged as continuous moving image frames, since a differential component is not present among the plural moving image frames, it is possible to compress the moving image frames at a high compression ratio. Even if only different characters are present in the respective divided areas, since a ratio of the characters in the respective moving image frames is often low, it is possible compress the moving image frames at a high compression ratio. In this way, the moving image frames in the same position among the plural document images are continuously compressed. This makes it possible to realize a high compression ratio compared with that realized when the respective document images are individually compressed. Compression/expansion processing employing this method is explained below.

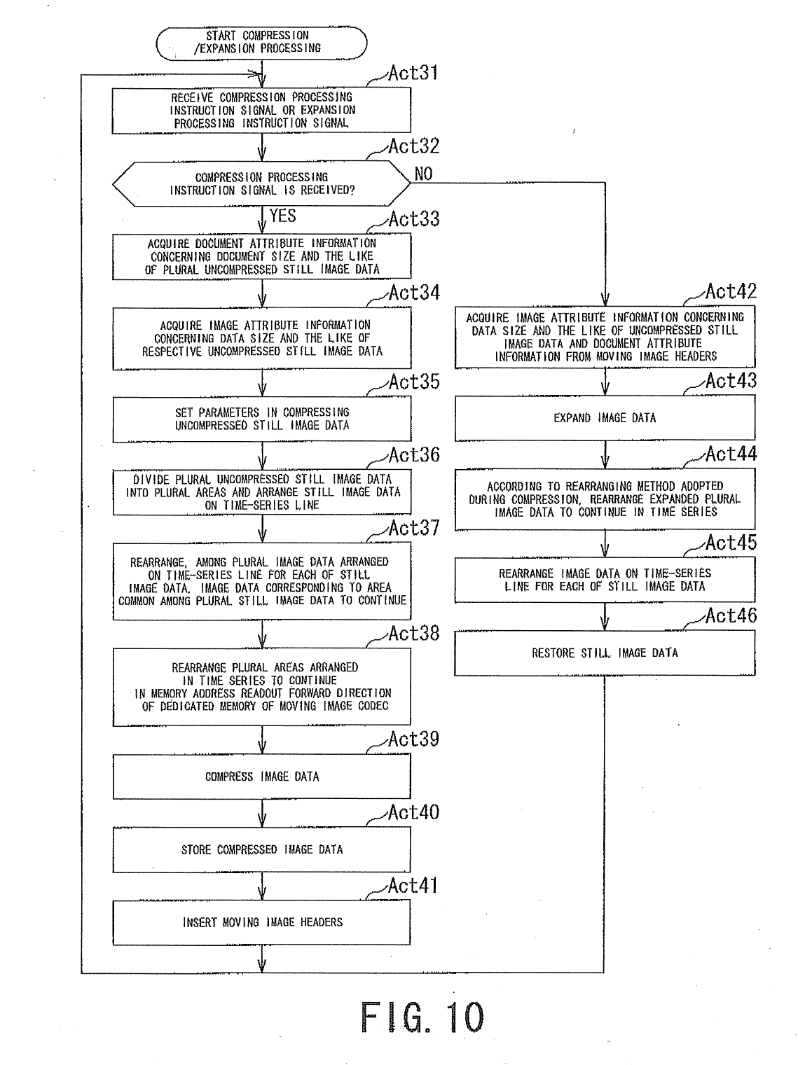

Another kind of compression/expansion processing in the image processing apparatus 1 shown in FIG. 1 is explained with reference to a flowchart shown in FIG. 10. ACTS 31 and 32, ACTS 35 and 36, ACTS 38 to 44, and ACT 46 in FIG. 10 are the same as ACTS 1 to 13 in FIG. 5. Since explanation of the acts is redundant, the explanation is omitted as appropriate.

In ACT 33, the CPU 31 of the control unit 11 acquires document attribute information concerning a document size and the like of plural uncompressed still image data via the image data interface 13 or the printer controller interface 34. The document attribute information includes at least information concerning the number of pages of a still image to be uncompressed, information concerning presence or absence of mixture of color and monochrome of the uncompressed still image, and information concerning presence or absence of mixture of still images with different sizes.

In ACT 36, in order to transfer the still image data to the moving image codec 37, the CPU 31 of the control unit 11 sequentially divides the respective still image data into plural areas according to a frame size set in the moving image codec 37. The CPU 31 of the control unit 11 treats, as moving image frames, respective image data corresponding to the respective areas divided according to the frame size used in the moving image codec 37 and arranges, for each of the still image data, the plural image data corresponding to the plural areas to logically continue in time series from the top in row and column order on the RAM 33.

In ACT 37, the CPU 31 of the control unit 11 continuously rearranges, among the plural image data arranged on the time-series line for each of the still image data, image data corresponding to the same divided area corresponding to a portion common in all the still image data. Thereafter, the processing proceeds to ACT 38 and processing in ACT 38 and subsequent acts is executed. When the processing is executed, in ACT 41, after the compression processing in the moving image codec 37, the CPU 31 of the control unit 11 inserts the document attribute information in the header areas of the generated compress-encoded moving image signals (compressed moving image data) together with the image attribute information concerning the data size and the like of the uncompressed still image data. Thereafter, the processing returns to ACT 31.

This makes it possible to compress the plural still image data at a high compression ratio compared with that realized when each of the still image data is individually compressed.

On the other hand, after the moving image codec 37 expands the decoded moving image signal in ACT 43, in ACT 44, the CPU 31 of the control unit 11 rearranges according to the rearranging method adopted during the compression, the image data in the divided areas corresponding to the decoded moving image signal stored in the dedicated memory to continue in time series on the RAM 33. In ACT 45, the CPU 31 of the control unit 11 rearranges, on the basis of the acquired image attribute information and document attribute information, the image data on a time-series line for each of the still image data. Thereafter, in ACT 46, the CPU 31 of the control unit 11 restores, on the basis of the acquired image attribute information and document attribute information, the image data in the divided areas corresponding to the decoded moving image signal (the frame image signal) stored in the RAM 33 to the original plural still image data.

This makes it possible to increase the number of pages that can be treated in one print processing, increase the number of documents that can be stored in the image processing apparatus 1, and realize electronic sorting processing for a document including a large number of pages.

In the field of videos, since the size and the resolution of screens are improved, it is also possible that a frame size of a moving image treated by the moving image codec 37 is larger than a document image treated in image formation and image input. Therefore, this embodiment may also be applied when the size (width and height) of a moving image frame treated by the moving image codec 37 is larger than the size of a document image inputted to the image processing apparatus 1. Consequently, in the image processing apparatus 1, it is possible to suitably compress or expand, using the moving image codec 37 that treats a high-resolution and large size frame, a still image smaller than the frame.

The series of processing explained in the embodiment of the present invention can be executed by software and can be executed by hardware as well.

In the image processing apparatus 1 in the embodiment of the present invention, the operation panel 17, the scanner unit 16, and the printer unit 12 are adapted to be respectively connected to the control unit 11. The image processing apparatus 1 integrally perform the image processing and the image compression/expansion processing in the embodiment of the present invention, but the present invention is not limited to this. For example, a part related to a compression or expansion function by the CPU 31 of the control unit 11 and the moving image codec 37 may be separated from the other part related to the image forming processing and the image compression processing function and the image expansion processing function in the embodiment of the present invention may be added as an option to the image processing apparatus 1.

In the example of the processing explained in the embodiment of the present invention, the acts of the flowcharts are executed in time series according to the described order. However, the present invention also includes processing that is not always executed in time series but executed in parallel or individually.

What is claimed is:

1. An image processing apparatus comprising:
an area dividing unit configured to divide still image data into plural areas in two directions orthogonal to each other,
an image-data arranging unit configured to arrange, continuously in time series, plural image data corresponding to the plural areas included in the still image data divided by the area dividing unit;
a compression encoding unit configured to compression-encode, using a moving image compression/expansion method, the plural image data corresponding to the plural areas arranged continuously in time series by the image-data arranging unit and generate a compression-encoded moving image signal;
a decoding unit configured to decode, using the moving image compression/expansion method, the compression-encoded moving image signal generated by the compression encoding unit and generate a decoded moving image signal; and
a still-image-data generating unit configured to generate still image data on the basis of the plural image data corresponding to the decoded moving image signal generated by the decoding unit.

2. The apparatus according to claim 1, further comprising a scan unit configured to scan image data concerning an original, wherein
the still image data is image data scanned by the scan unit.

3. The apparatus according to claim 1, wherein the still image data is raster image data of a document image.

4. The apparatus according to claim 1, further comprising:
an image-attribute-information acquiring unit configured to acquire image attribute information concerning the still image data; and
a header adding unit configured to adds as a header, the image attribute information acquired by the image-attribute-information acquiring unit to the compression-encoded image signal generated by the compression encoding unit.

5. The apparatus according to claim 1, wherein the image-data arranging unit rearranges the plural image data corresponding to the plural areas continuously arranged in time series to continue in a direction in which the compression encoding unit reads out the plural image data.

6. The apparatus according to claim 5, wherein the compression encoding unit compression-encodes the plural image data corresponding to the plural areas rearranged to continue in the direction in which the compression encoding unit reads out the plural image data.

7. The apparatus according to claim 6, wherein
the image-data arranging unit rearranges the plural image data corresponding to the decoded moving image signal generated by the decoding unit to continue in time series, and
the still-image-data generating unit generates the still image data on the basis of the plural image data rearranged in time series.

8. The apparatus according to claim 5, wherein, if one or plural image data corresponding to one or plural areas common among a plurality of the still image data are identical or similar, the image-data arranging unit rearranges the image data such that the image data corresponding to an area common among the plural still image data among the plural image data corresponding to the plural areas arranged continuously in time series continue.

9. The apparatus according to claim 1, wherein the compression encoding unit compression-encodes, if a difference in data is smaller than a predetermined reference value between image data among the plural image data arranged continuously in time series, the image data in a P frame or B frame format and, on the other hand, compression-encodes, if a difference in data is larger than a predetermined reference value between image data, the image data in an I frame format.

10. The apparatus according to claim 1, further comprising a display unit configured to display an image based on the decoded moving image signal generated by the decoding unit.

11. An image processing method comprising the steps of:
dividing still image data into plural areas in two directions orthogonal to each other;
arranging, continuously in time series, plural image data corresponding to the plural areas included in the still image data divided in the dividing of the still image data;
compression-encoding, using a moving image compression/expansion method, the plural image data corresponding to the plural areas arranged continuously in time series in the arranging of the plural image data and generating a compression-encoded moving image signal;
decoding, using the moving image compression/expansion method, the compression-encoded moving image signal generated in the compression-encoding of the plural image data and generating a decoded moving image signal; and
generating still image data on the basis of the plural image data corresponding to the decoded moving image signal generated in the decoding of the compression-encoded moving image signal.

12. The method according to claim 11, further comprising the step of scanning image data concerning an original, wherein
the still image data is image data scanned in the scanning of the image data.

13. The method according to claim 11, wherein the still image data is raster image data of a document image.

14. The method according to claim 11, further comprising the steps of:
acquiring image attribute information concerning the still image data; and
adding, as a header, the image attribute information acquired in the acquiring of the image attribute information to the compression-encoded image signal generated in the compression-encoding of the plural image data.

15. The method according to claim 11, wherein the plural image data corresponding to the plural areas continuously arranged in time series are rearranged to continue in a direction in which the plural image data are read out in the compression-encoding of the plural image data.

16. The method according to claim 15, wherein the plural image data corresponding to the plural areas rearranged to continue in the direction in which the plural image data are read out in the compression-encoding of the plural image data are compression-encoded in the compression-encoding of the plural image data.

17. The method according to claim 16, wherein
the plural image data corresponding to the decoded moving image signal generated in the in the decoding of the compression-encoded moving image signal are rearranged in the arranging of the plural image data to continue in time series, and
the still image data is generated on the basis of the plural image data rearranged in time series in the generating of the still image data.

18. The method according to claim 15, wherein, if one or plural image data corresponding to one or plural areas common among a plurality of the still image data are identical or similar, the image data is rearranged in the arranging of the plural image data such that the image data corresponding to an area common among the plural still image data among the plural image data corresponding to the plural areas arranged continuously in time series continue.

19. The method according to claim 11, wherein, if a difference in data is smaller than a predetermined reference value between image data among the plural image data arranged continuously in time series, the image data is compression-encoded in a P frame or B frame format in the compression-encoding of the plural image data and, on the other hand, if a difference in data is larger than a predetermined reference value between image data, the image data is compression-encoded in an I frame format in the compression-encoding of the plural image data.

20. The method according to claim 11, further comprising displaying an image based on the decoded moving image signal generated in the decoding of the compression-encoded moving image signal.
